(19) United States
(12) Patent Application Publication
(10) Pub. No.: US 2014/0172388 A1
(43) Pub. Date: Jun. 19, 2014

(54) GENERATING A MESH OF GEOMETRIC ELEMENTS

(71) Applicants: Soji Yamakawa, Pittsburgh, PA (US); Kenji Shimada, Pittsburgh, PA (US); Marc Zinck, Swissvale, PA (US)

(72) Inventors: Soji Yamakawa, Pittsburgh, PA (US); Kenji Shimada, Pittsburgh, PA (US); Marc Zinck, Swissvale, PA (US)

(73) Assignee: Carnegie Mellon University, Pittsburgh, PA (US)

(21) Appl. No.: 14/126,274

(22) PCT Filed: Jun. 15, 2012
(86) PCT No.: PCT/US2012/042633

§ 371 Date: Mar. 4, 2014

Related U.S. Application Data
(60) Provisional application No. 61/520,795, filed on Jun. 15, 2011.

(51) Int. Cl. G06F 17/50

(52) U.S. Cl. CPC G06F 17/5018
USPC 703/2

(57) ABSTRACT

A method performed by one or more processors, comprising: receiving information indicative of a geometric domain; generating, based on the information indicative of the geometric domain, a mesh of geometric elements; transforming a plurality of the geometric elements from a first type of geometric element to a second type of geometric element; and subdividing the plurality of the geometric elements transformed from the second type of geometric element into a third type of geometric element.

### CLAIM OF PRIORITY

This application claims priority under 35 U.S.C. §119(e) to provisional U.S. Patent Application 61/520,795, filed on Jun. 15, 2011, the entire contents of which are hereby incorporated by reference.

### BACKGROUND

Finite element analysis is a numerical method that solves mathematical problems in engineering and physics for determining the physical behavior of a geometric object or region. Finite element analysis is used in approximating a continuous physical characteristic or behavior of a geometric region by a discrete model of a set of piece-wise continuous functions. The geometric region is broken into discrete elements interconnected at discrete node points.

Generally, finite element analysis is performed on a computer in a three-step procedure comprising the steps of pre-processing, processing, and post-processing. In the pre-processing step, geometric boundary data representing the geometric region to be analyzed is taken, and a mesh of geometric elements covering the domain of the geometric region is generated. Generally, a mesh includes a grid of nodes and geometric elements. Typically, a node is a point at which different elements are jointed together. In an example, a mesh includes various types of geometric elements, including, e.g., tetrahedral elements, prism elements, pyramidal elements, hexahedral elements, and so forth. In this example, generation of a mesh includes the process of discretizing a continuous geometry into small elements for use in the finite element analysis.

In the processing step, mathematical equations are applied to the geometric elements to solve for characteristics of interest. For example, a stimulus is applied to the mesh and the reaction of the mesh to the stimulus is analyzed. In the post-processing step, the results of this finite element analysis are output, for example, in a graphical representation of the characteristic of interest.

In an example, a “plastering” method is used in generating a hexahedral mesh. In the plastering method, layers of hexahedral elements are placed in the mesh from the boundary inward. In this example, the fronts of the hexahedral elements collide, which may result in difficulty in transforming hexahedral elements so that two fronts meet in a conformal connection.

In another example, pyramidal elements may be used in generating hexahedral meshes. Unlike hexahedral, prism, and tetrahedral elements, a pyramidal element cannot be subdivided into a hexahedral element using a mid-point subdivision template. Generally, a mid-point subdivision template includes a definition of a format for dividing an object (e.g., a line) at its midpoint. Rather, a pyramidal subdivision template subdivides a pyramidal element into hexahedral elements and conforms to the mid-point subdivision templates of the neighboring hexahedral, prism, and tetrahedral elements. Generally, a pyramidal subdivision template includes a format for dividing a pyramid into other geometric elements.

In this example, a pyramidal subdivision template includes numerous hexahedral elements, and includes some elements that are of relatively low quality. As a result of a pyramidal element being subdivided into many elements, applying this template creates a surge in the node density where pyramidal elements are located, e.g., resulting in a non-uniform density distribution that can adversely affect finite-element simulation accuracy.

### SUMMARY

In one aspect of the present disclosure, a method performed by one or more processors includes receiving information indicative of a geometric domain; generating, based on the information indicative of the geometric domain, a mesh of geometric elements; transforming a plurality of the geometric elements from a first type of geometric element to a second type of geometric element; and subdividing the plurality of the geometric elements transformed from the second type of geometric element into a third type of geometric element.

Implementations of the disclosure can include one or more of the following features. In some implementations, the first type of geometric element includes one or more a tetrahedral element, a prism element and a hexahedral element; and wherein the third type of geometric element includes a hexahedral element. In other implementations, transforming includes: applying a topological transformation. In other implementations, the method further includes determining, based on one or more characteristics of the mesh, a type of the topological transformation to be applied.

In some implementations, the type of topological transformation includes one or more of: an edge collapse topological transformation; a prism swap topological transformation; a prism collapse topological transformation; a prism split topological transformation; a clamp topological transformation; a diamond collapse topological transformation; a half and full-wedge collapse topological transformation; and a prism pairing topological transformation. In other implementations, transforming includes: applying a smoothing operation to the geometric elements in the mesh; wherein application of the smoothing operation removes from the mesh one or more of the geometric elements of the first type. In still other implementations, subdividing includes: subdividing based on a mid-point subdivision template. In yet other implementations, the mesh includes a substantially uniform node distribution following subdividing.

In still another aspect of the disclosure, one or more machine-readable media are configured to store instructions that are executable by one or more processors to perform operations including receiving information indicative of a geometric domain; generating, based on the information indicative of the geometric domain, a mesh of geometric elements; transforming a plurality of the geometric elements from a first type of geometric element to a second type of geometric element; and subdividing the plurality of the geometric elements transformed from the second type of geometric element into a third type of geometric element. Implementations of this aspect of the present disclosure can include one or more of the foregoing features.

In still another aspect of the disclosure, an electronic system includes one or more processors; and one or more machine-readable media configured to store instructions that are executable by the one or more processors to perform operations including: receiving information indicative of a geometric domain; generating, based on the information indicative of the geometric domain, a mesh of geometric elements; transforming a plurality of the geometric elements from a first type of geometric element to a second type of geometric element; and subdividing the plurality of the geometric elements transformed from the second type of geometric element into a third type of geometric element. Implementations of this aspect of the present disclosure can include one or more of the foregoing features.

All or part of the foregoing can be implemented as a computer program product including instructions that are stored on one or more non-transitory machine-readable storage media, and that are executable on one or more processors. All or part of the foregoing can be implemented as an apparatus, method, or electronic system that can include one or more processors and memory to store executable instructions to implement the stated operations.

The details of one or more implementations are set forth in the accompanying drawings and the description below. Other features, objects, and advantages will be apparent from the description and drawings, and from the claims.

### BRIEF DESCRIPTION OF THE FIGURES

FIG. 1 shows a schematic of mesh generation for a 2D object.

FIG. 2 is a diagram of a tetrahedral mesh.

FIGS. 3-4 are diagrams of a tetrahedral mesh following application of various conformal transformations.

FIG. 5 is a diagram of a hexahedral mesh.

FIG. 6 is an example of a network environment for generating a mesh.

FIG. 7 is a diagram of an edge used by tetrahedral elements.

FIGS. 8A-8B are diagrams of an edge-collapse transformation.

FIGS. 9A-9B are diagrams of a prism-swap transformation.

FIGS. 10A-10B are diagrams of a prism-swap transformation.

FIG. 11 is a diagram of a prism-chain pair and connected tetrahedral elements that can be collapsed.

FIGS. 12A-12B are diagrams of a prism-collapse transformation.

FIGS. 13A-13C are diagrams of a prism-split transformation.

FIGS. 14A-14B are diagrams of a clamp transformation.

FIGS. 15A-15B are diagrams of a diamond-collapse transformation.

FIGS. 16A-16B are diagrams of a half-wedge collapse transformation.

FIGS. 17A-17B are diagrams of a prism-pairing transformation.

FIGS. 18A-18C are diagrams of side faces.

FIGS. 19A-19F are diagrams of prism-layer insertion.

FIGS. 20A-20G are diagrams of mesh generation.

FIG. 21 is a flowchart showing a process for generating a mesh.

FIG. 22 is a block diagram of components in the example environment for generating meshes.

### DETAILED DESCRIPTION

Described herein is a system for generating meshes (e.g., hexahedral meshes) with an increased amount of conformal connections among elements, e.g., relative to an amount of conformal connections among elements in other meshes generated using other techniques. In an example, the system generates a fully-conformal mixed mesh. In some examples, the meshes generated may have a substantially uniform node distribution. Generally, uniform node distribution includes an evenly spaced distribution of nodes in an object (e.g., in a mesh). In this example, the system is configured to generate meshes with a decreased amount of surges in node density in various portions of the mesh, e.g., relative to the amount of surges in node density of meshes generated using other techniques. The system is configured to generate meshes for various types of solids, including, e.g., thin-walled solids, solids with thin-walled regions and thick-walled regions, and so forth.

The system is configured to generate the mesh based on implementations of various techniques, including, e.g., pillowing (e.g., prism-tetrahedral pillowing), conformal transformation, and subdivision (e.g., hexahedral mesh subdivision), each of which are described in further detail below. Generally, pillowing includes a technique in which a mesh of geometric elements is generated for a particular geometric domain. Generally, a geometric domain includes information indicative of a set of points included in an outline of an object and/or information indicative of a shape of an object. Generally, a conformal transformation includes a conversion of one type of geometric element to another type of geometric element.

For example, the system implements prism-tetrahedral pillowing by generating a tetrahedral mesh of an input geometric domain and inserting a layer of prism elements on boundary of the tetrahedral mesh. The system implements conformal transformation by applying a sequence of topological transformations and smoothing operations to the tetrahedral mesh to promote a reduction in tetrahedral elements between prism elements in the mixed mesh comprised of tetrahedral, prism, and hexahedral elements. Generally, a smoothing operation includes a technique for making a level, or continuously even, surface. Generally, a topological transformation includes a modification in properties of geometric figures or solids.

Additionally, in conformal transformation, some prism elements are converted to hexahedral elements. The system implements hexahedral mesh subdivision by subdividing the elements of the tetrahedral mesh into hexahedral elements, e.g., through application of mid-point subdivision.

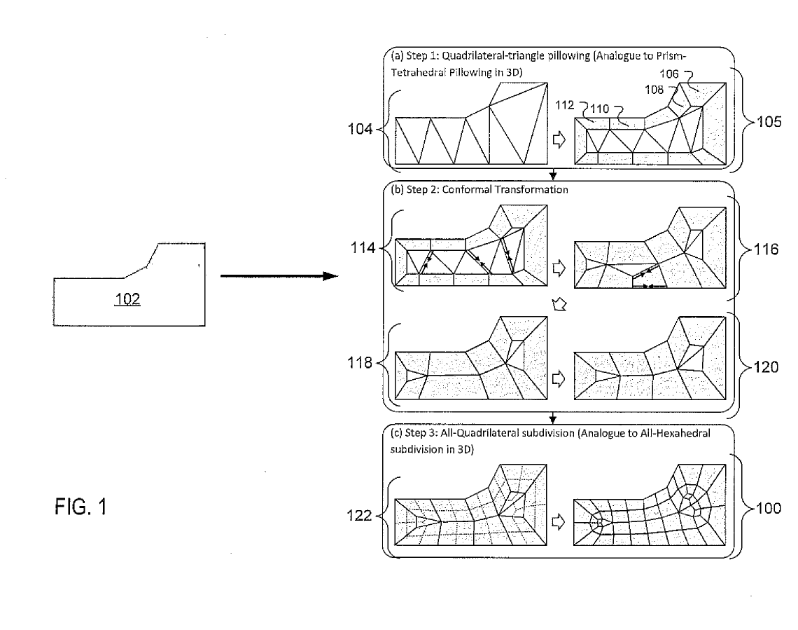

In an example, the system may be configured to generate a mesh for objects of various dimensions, including, e.g., a two-dimensional (“2D”) object, a three-dimensional (“3D”) object, and so forth. Referring to FIG. 1, the system generates quadrilateral mesh 100 for geometric domain 102 (e.g., a 2D object). In this example, the system generates triangular mesh 104 for geometric domain 102. The system also generates mesh 105 by inserting a layer of quadrilateral elements 106, 108, 110, 112 on the boundary of triangular mesh 104.

The system generates meshes 114, 116, 118, 120 by performing a sequence of topological transformations and smoothing operations on mesh 105. In the example of FIG. 1, the topological transformations and smoothing operations generate mesh 120, in which the number of triangular elements is reduced, e.g., relative to the number of triangular elements in mesh 105. The system generates meshes 100, 122 by subdividing the elements in mesh 120 into quadrilateral elements.

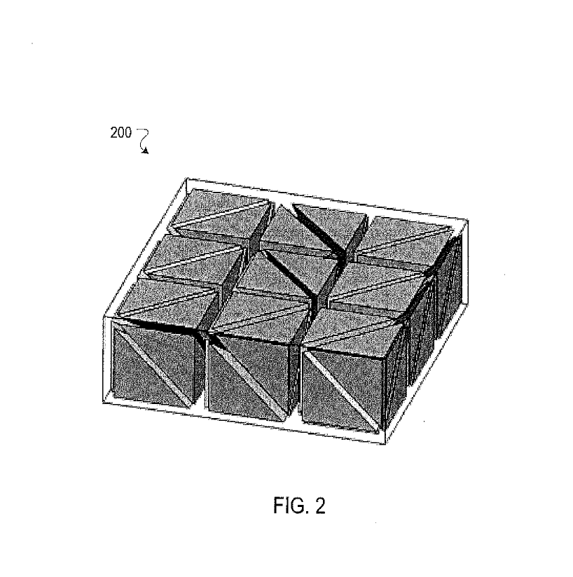

In another example, the system is configured to generate a hexahedral mesh for a 3D object (e.g., a thin walled object). Referring to FIG. 2, the system implements pillowing by generating tetrahedral mesh 200 of an input geometric domain (not shown). The system generates tetrahedral mesh 200 using a tetrahedral mesh-generation scheme, e.g., as is known in the art. In this example, the system also inserts a layer of prism elements on the boundary of the tetrahedral mesh 200, e.g., using a well-known boundary-layer element generation scheme.

The system applies to tetrahedral mesh 200 a sequence of topological transformations and smoothing operations resulting in a reduction of the number of tetrahedral elements and an increase in the number of hexahedral elements, while maintaining the mesh conformity. In an example, the system applies smoothing operations that are based on schemes including linear-programming methods, volume equalization methods, and angle-based smoothing methods. In this example, the smoothing operations improve the quality of the geometric elements in a mesh and also increase the applicability of the topological transformations.

In an example, an effectiveness of the topological transformations is reduced if the topological transformations generate an inverted element in the mesh, e.g., relative to an effectiveness of the topological transformations without an inverted element. In this example, the higher quality geometric elements generated through the smoothing operations reduce a probability of generating an inverted element through the topological transformations, e.g., relative to a probability of generating an inverted element without having performed the smoothing operations. Through use of the smoothing operation, an effectiveness of the topological transformations is increased, e.g., relative to an effectiveness of the topological transformations without having performed the smoothing operations.

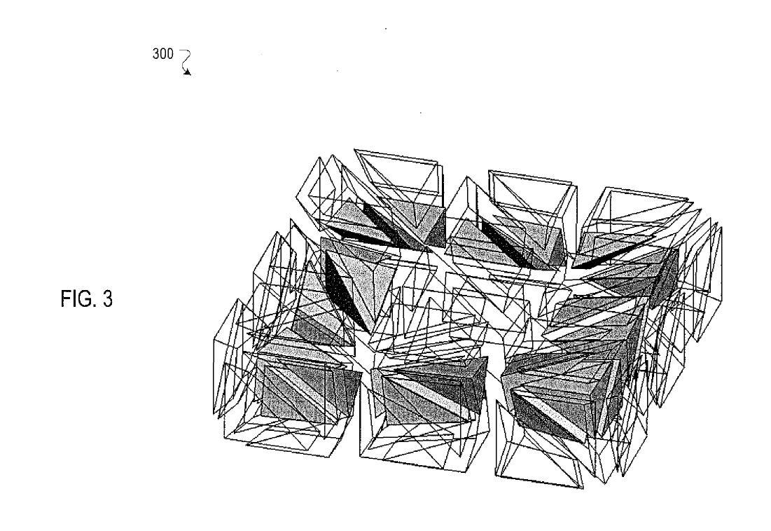

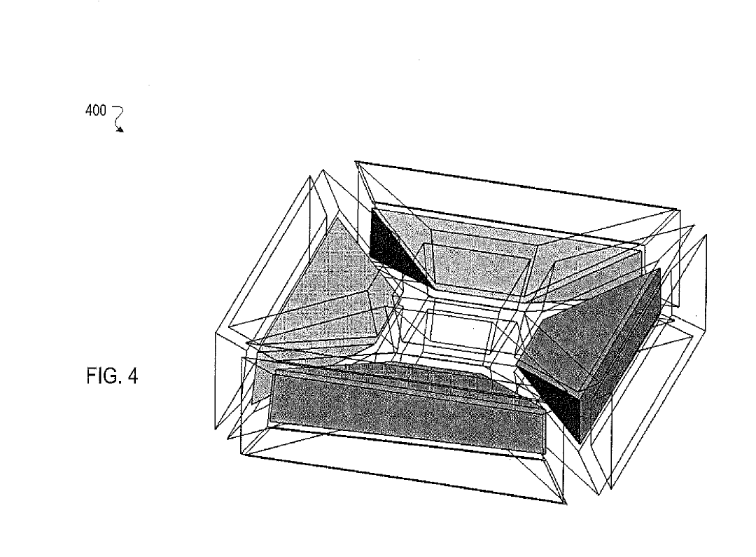

In this example, a variety of topological transformations are applied in order to achieve edge-collapse and clamp transformations, each of which are described in further detail below. Referring to FIG. 3, the system generates mesh 300 through edge-collapse transformations, which eliminate tetrahedral elements that lay between prism elements. The system performs clamp transformations (e.g., on mesh 300) that convert some prism elements into hexahedral elements, and some tetrahedral elements into a prism element. Referring to FIG. 4, the system generates mesh 400 by applying smoothing operations (e.g., on mesh 300) until no more tetrahedral elements can be removed from mesh 300.

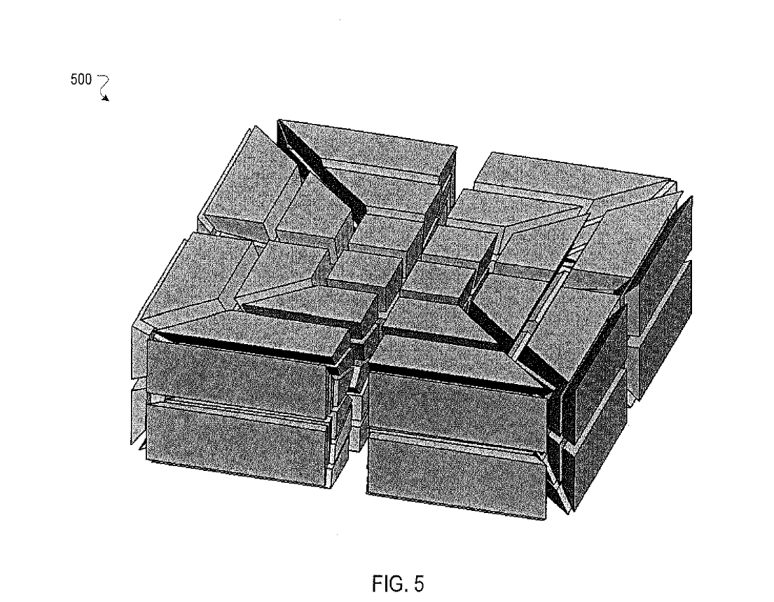

Referring to FIG. 5, the system generates hexahedral mesh 500 by subdividing the elements in a mixed mesh (e.g., a mesh including hexahedral elements, prism elements, and/or tetrahedral elements) into hexahedral elements by applying mid-point subdivision templates. In this example, the mixed mesh may include one of meshes 300, 400, which remains conformal and does not include pyramidal elements. In this example, mesh 500 remains conformal (e.g., through the various actions performed in generating mesh 500) and does not include a pyramidal element.

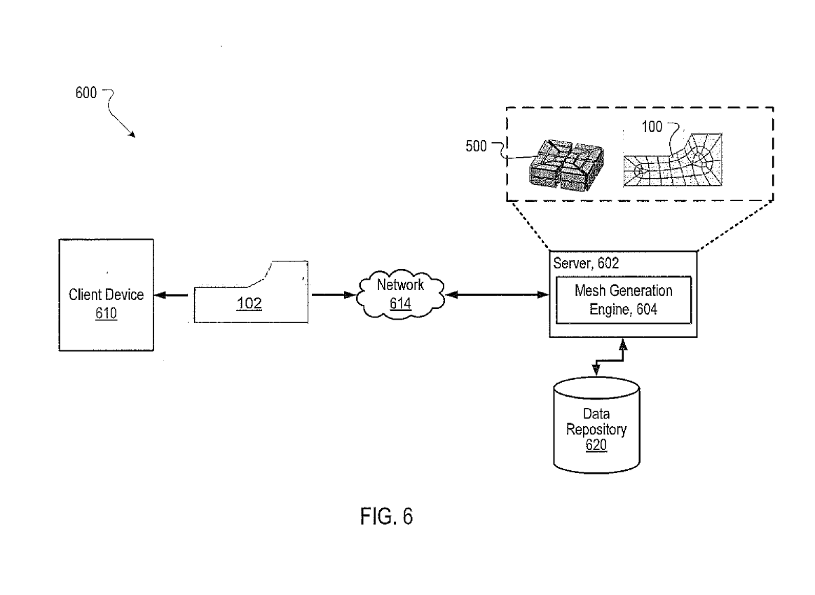

Referring to FIG. 6 a block diagram is shown of an example environment 600 in which server 602 generates meshes, including, e.g., meshes 100, 500. The example environment 600 includes network 614, including, e.g., a local area network (LAN), a wide area network (WAN), the Internet, or a combination thereof. Network 614 connects client device 610 and server 602. The example environment 600 may include many thousands of client devices and content item management systems. The example environment 600 also includes data repository 620 for storing numerous items of data, including, e.g., data indicative of meshes 100, 500.

Client device 610 includes a personal computer, a laptop computer, and other devices that can send and receive data over network 614. In the example of FIG. 6, client device 610 sends, to server 602, geometric domain 102. In this example, server 602 includes mesh generation engine 604. Using geometric domain 102, mesh generation engine 604 is configured to generate mesh 100, e.g., using the techniques described above. Using other geometric domains (not shown), mesh generation engine 604 is also configured to generate numerous other types of meshes, including, e.g., mesh 500.

In an example, mesh generation engine 604 is configured to generate a mesh (e.g., hexahedral mesh 500) by performing pillowing, conformal transformation, and subdivision. In this example, mesh generation engine 604 is configured to implement various techniques in performing conformal transformation. As described in further detail below, conformal transformation reduces a number of tetrahedral elements in a mesh and increases a number of hexahedral elements, e.g., while maintaining mesh conformity. Additionally, the techniques for conformal transformation, implemented by mesh generation engine 604, transform a hexahedral, prism, and/or tetrahedral mixed mesh, e.g., without introducing pyramidal elements.

In an example, mesh generation engine 604 implements conformal transformation through execution of various topological transformations. Many of the topological transformations transform a prism-chain pair, including, e.g., a collection of prism elements. For example, a prism-chain pair includes a pair of sets of prism chains. Generally, a prism chain includes a single prism element or a set of prism elements that are connected to at least one other member of the set by a triangular face. Prism chains are classified as either open or closed. An open prism chain includes at least one triangular face as part of a mesh boundary or at least one triangular face that interfaces with a tetrahedral element. A closed prism chain includes a set of prisms that are connected to two other members of the set, one on each triangular face. In an example, a closed prism chain has no triangular faces that are not connected to another prism in the prism chain.

In an example, two prism chains may form a prism-chain pair when the following conditions are met: (1) the prism chains include a same number of elements, (2) each of the prism elements in one prism chain has a prism element in the other prism chain that shares a quadrilateral face, and (3) each of the triangular faces of one prism chain has a triangular face in the other prism chain that shares an edge. A prism-chain pair has a column of quadrilateral faces (e.g., “gluing faces”), each of which is shared by a prism element in one prism chain and a prism element in the other prism chain. A prism-chain pair also has a column of edges, each of which is shared by two triangular faces within the prism-chain pair. Such edges are called rib edges. The number of gluing faces is the same as the number of prism element included in each of the prism chains forming the prism-chain pair. Additionally, the number of rib edges is equal to the number of the gluing faces plus one if the prism-chain pair is open, or the number of the gluing faces if prism-chain pair is closed.

Mesh generation engine 604 is configured to implement numerous types of topological transformations (e.g. depending on a shape of the geometric domain), including, e.g., an edge collapse topological transformation (“edge collapse”), a prism swap topological transformation (“prism swap”), a prism collapse topological transformation (“prism collapse”), a prism split topological transformation (“prism split”), a clamp topological transformation (“clamp”), a diamond collapse topological transformation (“diamond collapse”), a half and full-wedge collapse topological transformation (“half and full-wedge collapse”), and a prism pairing topological transformation (“prism pairing”). As described in further detail below, these topological transformations reduce a number of tetrahedral elements in a mesh and increase the number of prism and hexahedral elements in the mesh, e.g., relative to a number of tetrahedral elements and a number of prism and hexahedral elements in a mesh generated using other techniques.

In an example, mesh generation engine 604 is configured to identify a type of topological transformation to be implemented, based on characteristics of a geometric domain input into mesh generation engine 604. Generally, a characteristic includes a feature and/or an attribute of a geometric domain. For example, a characteristic of a geometric domain includes a shape of the geometric domain. In another example, mesh generation engine 604 is configured to identify a type of topological transformation based on characteristics of a mesh on which the topological transformation is performed. Characteristics of the mesh include types of geometric elements included in the mesh, a number of geometric elements included in the mesh, a placement (e.g., a juxtaposition) of the geometric elements with regard to each other in the mesh, and so forth.

### Edge Collapse

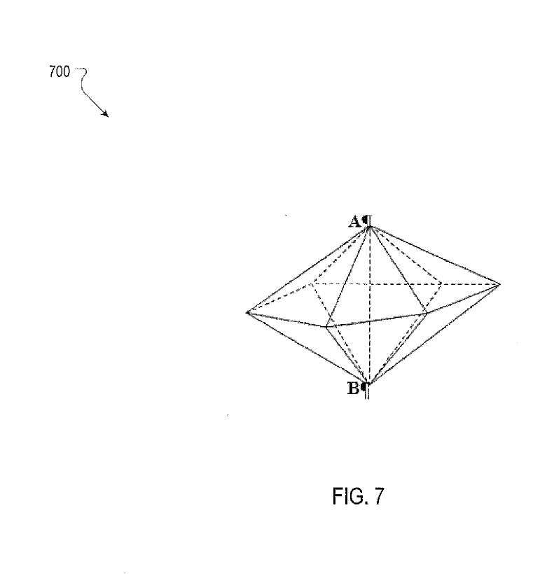

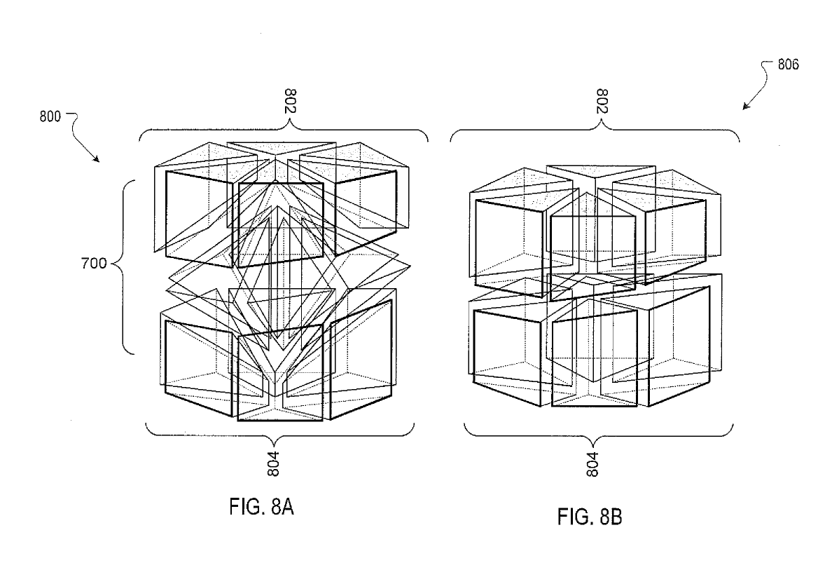

In an example, mesh generation engine 604 is configured to collapse an edge (e.g., of a geometric element in a mesh) used by tetrahedral elements. In another example, mesh generation engine 604 is configured to delete tetrahedral elements using the edge. In this example, the two nodes of the edge are merged together. Referring to FIG. 7, an edge defined by nodes A and B of geometric element 700 is shared by six tetrahedral elements and can be collapsed. Referring to FIG. 8A, geometric element 800 is shown. Geometric element 800 includes geometric element 700. In the example of FIG. 8A, nodes A and B of geometric element 700 are used by prism elements 802, 804. Referring to FIG. 8B, mesh generation engine 604 generates geometric element 806 by collapsing geometric element 700, such that prism elements 802 sharing node A connect to prism elements 804 sharing node B.

### Prism Swap

Mesh generation engine 604 implements prism-swap by re-connecting, or swapping, a column of gluing faces in a prism-chain pair. In an example, the two prism elements sharing a gluing face have a combined four edges that may not used by the four triangular faces of two prism elements. Two of the four edges are connected by a gluing face, and the remaining two are not directly connected. The prism-swap transformation replaces the two prism elements with two new prism elements such that the new gluing face connects the two the edges that were not connected in the original configuration and disconnects the edges that where originally connected.

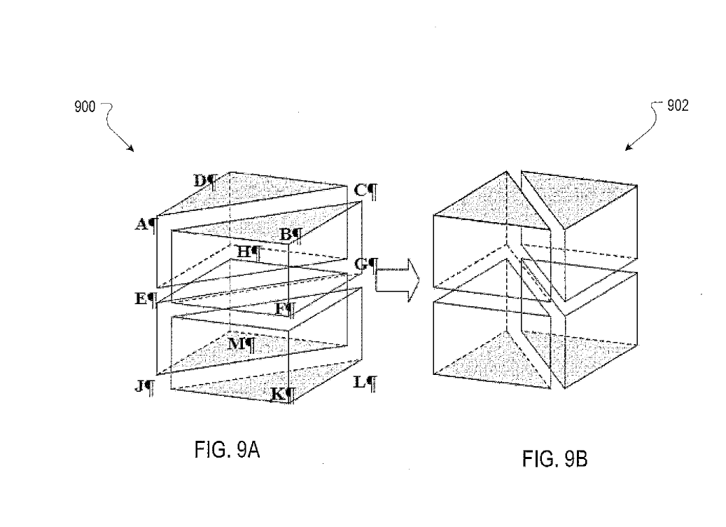

Referring to FIG. 9A, prism-chain pair 900 includes one chain of prism elements ABCEFG and another chain of prism elements ACDEGH. In this example, the matching pair includes prism elements EFGJKL and EGHJLM. Triangular faces ABC, ACD, LKJ, and LJM are on the mesh boundary. Referring to FIG. 9B, mesh generation engine 604 generates element 902 by swapping the gluing faces and replacing the prism elements in the prism chain pair with new prism elements ABDEFH, DBCHFG, EFHJKM, and FGHKLM.

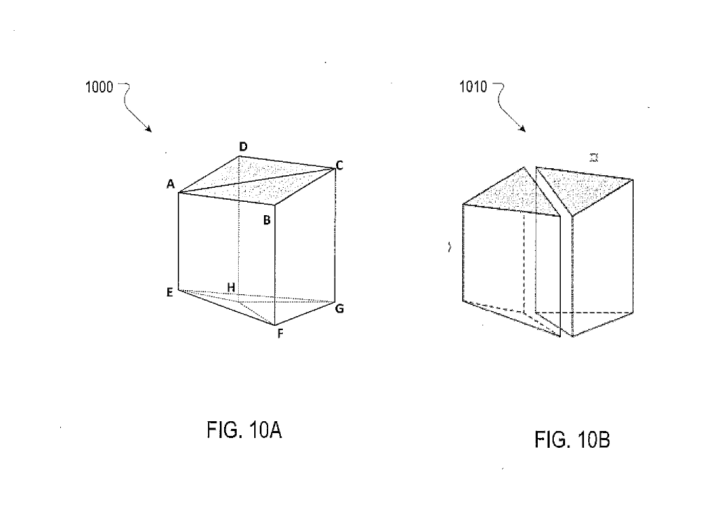

If a tetrahedral element shares four nodes of one end of a prism-chain pair, the tetrahedral element is removed by the prism-swap transformation. Referring to FIG. 10A, a sub-volume of mesh 1000 is filled with a pair of prism elements ABCEFG and ACDEGH (triangular faces ABC and CDE are exterior faces and not connected to other elements) and a tetrahedral element FHGE as shown. Referring to FIG. 10B, mesh generation engine 604 generates mesh 1010 by replacing the three elements with two prism elements ABDEFH and BCDFGH. Since the exterior of the sub-volume that is connected to other elements remains unchanged, the conformity of meshes 1000, 1010 is maintained.

### Prism Collapse

Mesh generation engine 604 implements prism-collapse by collapsing a rib edge in a prism-chain pair into one node, e.g., to delete the elements sharing a rib edge. A rib edge at an end of the prism-chain pair can be used by tetrahedral elements, which are deleted by the prism collapse transformation.

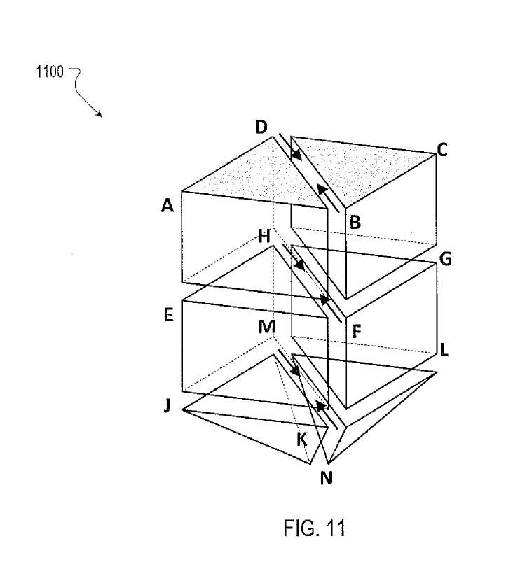

Referring to FIG. 11, mesh generation engine 604 uses prism collapse to collapse the prism and tetrahedral elements in mesh 1100. For example, prism elements ABDEFH, BCDFGH, EFHJKM, FGHKLM, and tetrahedral elements JKMN, KLMN, can be deleted by collapsing edges BD, FH, and KM into one node each.

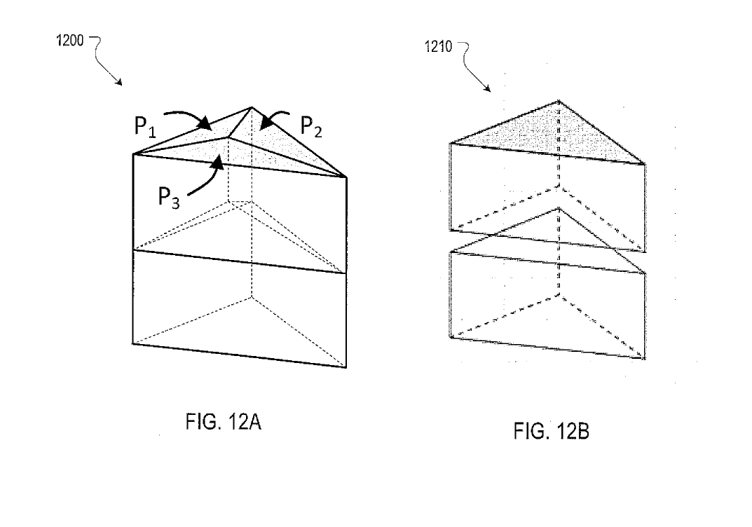

In an example, mesh generation engine 604 is configured to implement prism collapse when three prism elements share an edge, the three prism elements are connected to a single tetrahedral element, and the other side of each prism element is exposed to the exterior of the mesh. For example, referring to FIG. 12A, mesh 1200 includes prism elements P1, P2, and P3. In the example of FIG. 12B, mesh generation engine 604 generates mesh 1210 by collapsing prism elements P1, P2, and P3 and deleting a tetrahedral element.

Mesh generation engine 604 is also configured to implement prism collapse when four prism elements share an edge, two of them are connected to a single tetrahedral element, and the remaining two are connected to another single tetrahedral element.

### Prism Split

Mesh generation engine 604 implements prism-split by splitting a prism element in a prism-chain pair into two prism elements by inserting a node on each rib edge. If tetrahedral elements are using a rib edge at an end of the prism-chain pair, each of those tetrahedral elements are also split into two.

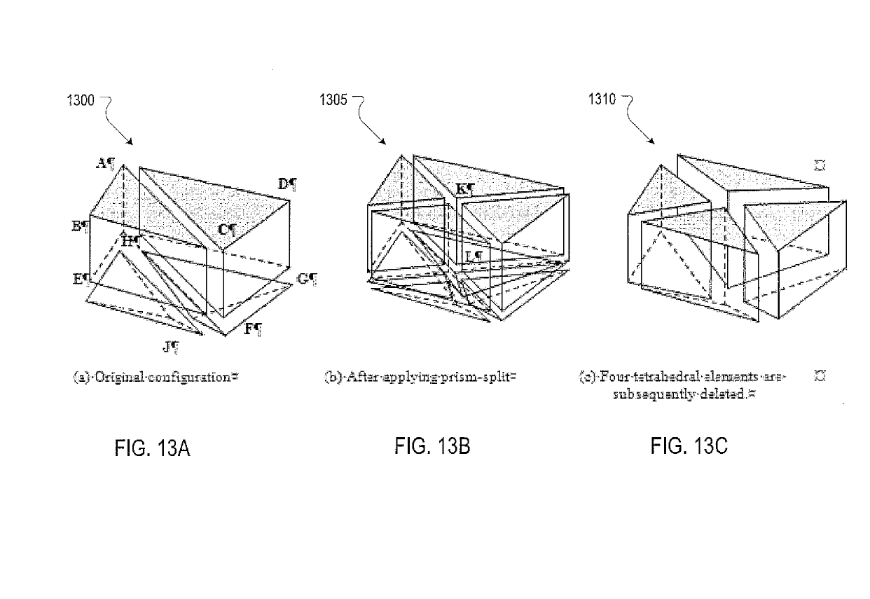

Referring to FIG. 13A, mesh 1300 is shown. Mesh 1300 includes two prism elements ABCEFH and ACDHFG sharing a gluing face AHFC. Additionally, two tetrahedral elements EFHJ and HFGJ are connected to the pair of the prism elements.

Referring to FIG. 13B, mesh generation engine 604 generates mesh 1305 by implementing prism split and inserting node K on edge AC and node L on HF. Additionally, prism element ABCEFH is split into two prism elements, ABKHEL and BCKEFL. Prism element ACDHFG is split into two prism elements, AKDHLG and CDKFGL. Tetrahedron EFHJ is split into two tetrahedral elements, ELHJ and EFLJ, and tetrahedron HFGJ is split into two tetrahedral elements, HLGJ and FGLJ. Referring to FIG. 13C, mesh generation engine 604 generates mesh 1310 by merging node L to node J and deleting the four tetrahedral elements.

### Clamp

Mesh generation engine 604 implements clamp transformation by converting three tetrahedral elements with three connected prism-chain pairs into one prism element with three chains of hexahedral elements. This transformation reduces a number of tetrahedral elements and converts pairs of prism elements into single hexahedral elements.

In an example, four conditions promote performance of the clamp transformation. The four conditions include that (1) three tetrahedral elements share an edge and are comprised of six nodes, (2) three prism-chain pairs are connected to the three tetrahedral elements, (3) the other side of the three prism chain pairs are exposed to the exterior of the mesh, and (4) two triangular faces of the three tetrahedral element cluster that are exposed outside the three tetrahedral elements and not connected to the three prism chain pairs do not share any nodes.

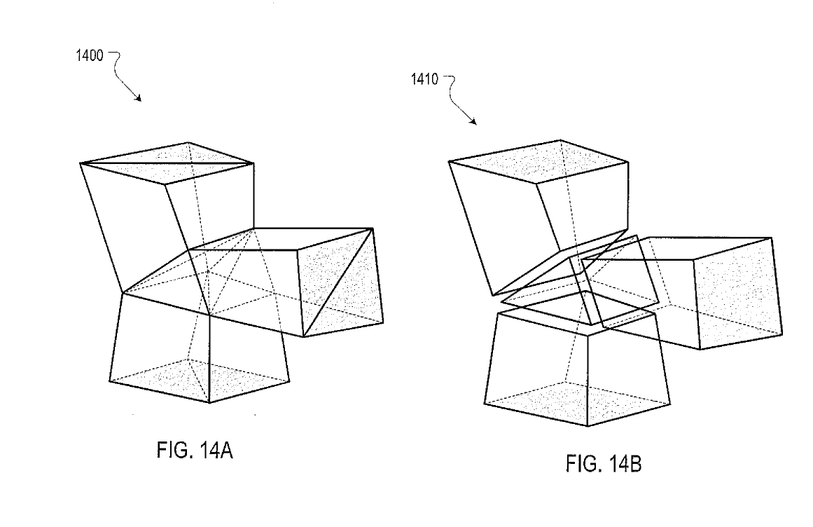

Referring to FIG. 14A, configuration 1400 satisfies the above conditions. Referring to FIG. 14B, mesh generation engine 106 generates mesh 1410 through application of the clamp transformation. Mesh 1410 includes one prism and three hexahedral elements.

### Diamond Collapse

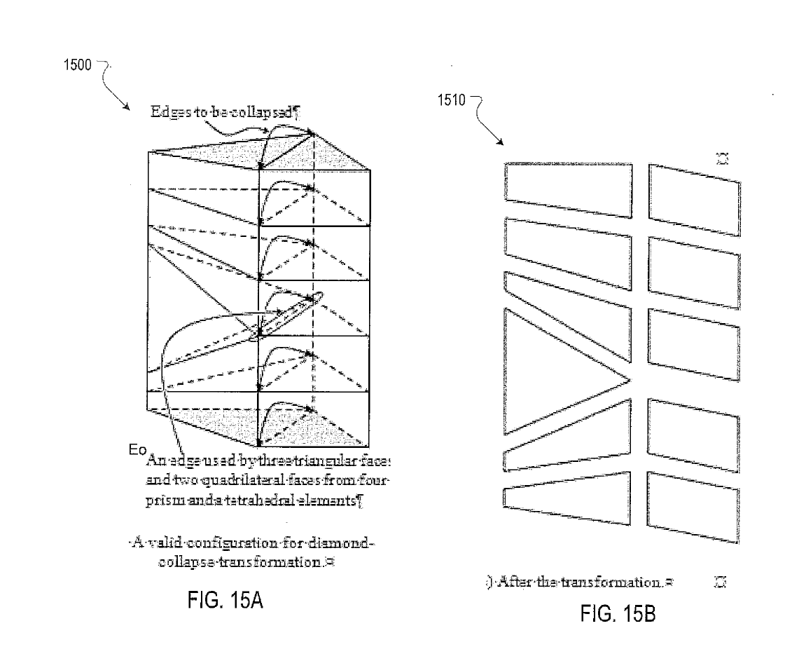

Mesh generation engine 604 implements diamond collapse by deleting and collapsing prism chains and tetrahedral elements. Referring to FIG. 15A, mesh generation engine 604 is configured to implement diamond collapse on mesh 1500, e.g., when an edge, edge E₀, is shared by three triangular and two quadrilateral faces such that the two quadrilateral faces are separated by one of the triangular faces and that the 3D elements that share edge E₀ are four prism elements plus a tetrahedral element. In this example, two of the three prism chains to be deleted by this transformation start from the triangular faces of the tetrahedral element sharing edge E₀ and continue to the boundary of mesh 1500. The third prism chain includes the third triangular face sharing edge E₀. Each prism element in the third prism chain shares a quadrilateral with a prism element in one of the first two chains. Both ends of the third prism chain must be exposed to the exterior of the boundary. If the above conditions are satisfied, edge E₀ and each edge shared by two triangular faces of the three prism chains can be collapsed to a node. The diamond-collapse transformation maintains mesh conformity.

Referring to FIG. 15B, mesh generation engine 106 generates diamond-collapse transformation 1510 by applying diamond collapse to a set of prism and tetrahedral elements. In the example of FIG. 15B, diamond-collapse transformation 1510 includes quadrilateral and triangular faces.

### Half and Full-Wedge Collapse

Mesh generation engine 604 implements half and full-wedge collapse by collapsing and deleting prism chains and tetrahedral elements. In an example, mesh generation engine 604 is configured to implement half and full-wedge collapse when various conditions are satisfied, including, e.g., one edge is shared by two triangular faces and a quadrilateral face from two prism and one tetrahedral elements, the other end of the two prism chains are exposed to the mesh boundary, and the two prism chains form a prism-chain pair, and so forth.

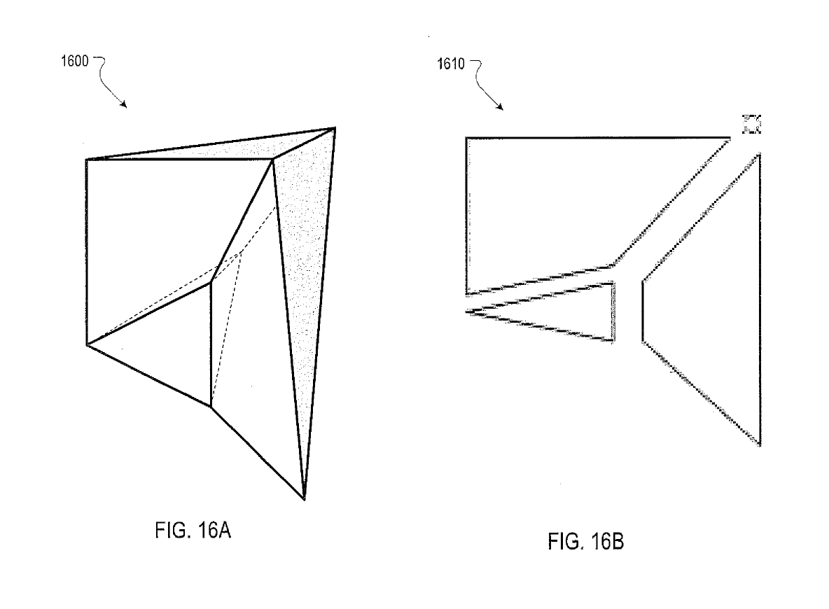

Referring to FIG. 16A, mesh generation engine 604 applies half and full-wedge collapse to mesh 1600. Referring to FIG. 16B, mesh generation engine 604 generates transformation 1610, e.g., following implementation of half and full-wedge collapse. In transformation 1610, each of the edges in the prism-chain pair shared by two triangular faces is collapsed into one node, and the tetrahedral element and the prism elements in the prism chains are deleted.

### Prism Paring

Mesh generation engine 604 implements prism pairing by merging prisms sharing a quadrilateral face included in a prism-chain pair. In an example, mesh generation engine 604 is configured to implement prism pairing when various conditions are satisfied, including, e.g., when both end faces of the prism-chain pair are exposed to the exterior of the mesh, when the prism-chain pair is a closed prism-chain pair (e.g., none of the triangular faces is exposed to the outside of the prism-chain pair).

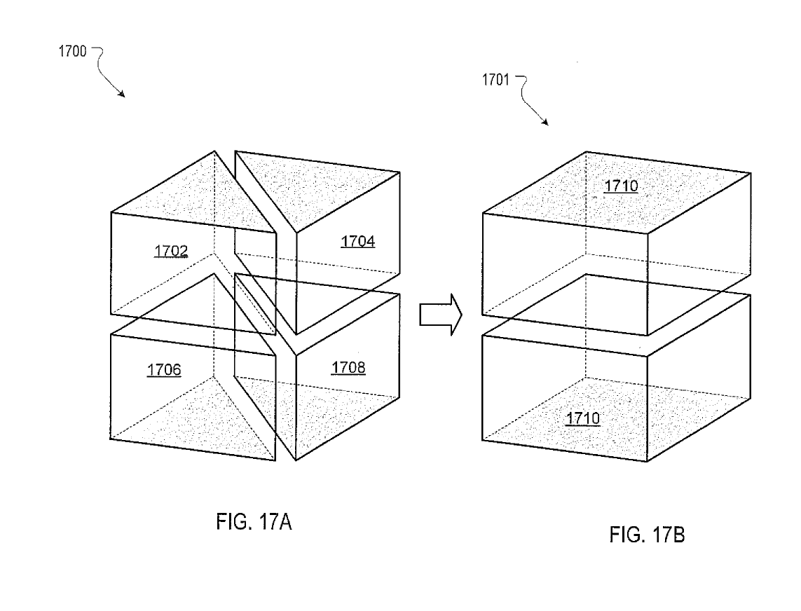

Referring to FIG. 17A, mesh generation engine 604 performs prism pairing on mesh 1700. Mesh 1700 includes prisms 1702, 1704, 1706, 1708. Referring to FIG. 17B, mesh generation engine 604 generates mesh 1701, from mesh 1700, by merging prisms 1702, 1704 into quadrilateral 1710 and merging prisms 1706, 1708 into quadrilateral 1712.

### Doublet Prevention During Topological Transformation

In an example, mesh generation engine 604 is configured to implement techniques to prevent doublets from occurring, e.g., during topological transformations. Generally, a doublet includes a configuration where two neighboring elements share two faces. At least one of the elements in a doublet will have a zero or a negative value Jacobian, which increases the difficulty of finite element analysis, e.g., relative to the difficulty of finite element analysis with a zero or a negative value Jacobian.

In an example, a doublet can occur when an edge connecting nodes of elements that share a face is collapsed. In another example, a doublet occurring when an edge is used by two prism elements and a hexahedral element, and one of the prism elements is collapsed by the prism-collapse transformation. In this example, the remaining prism element and the hexahedral element will form a doublet. In the foregoing example, one of the elements in the doublet will have a zero or negative Jacobian value, e.g., resulting in a geometrically invalid mesh.

Since at least one of the elements in a doublet has a zero or negative Jacobian, mesh generation engine 604 is configured to prevent the generation of doublets by preventing the creation of elements with a zero or negative Jacobian. In an example, mesh generation engine 604 calculates a decreased scaled Jacobian (e.g., minimum scaled Jacobian) determinant of geometric elements resulting from a transformation. In this example, if the computed value is less than a given threshold, mesh generation engine 604 does not apply the transformation.

### Side Faces

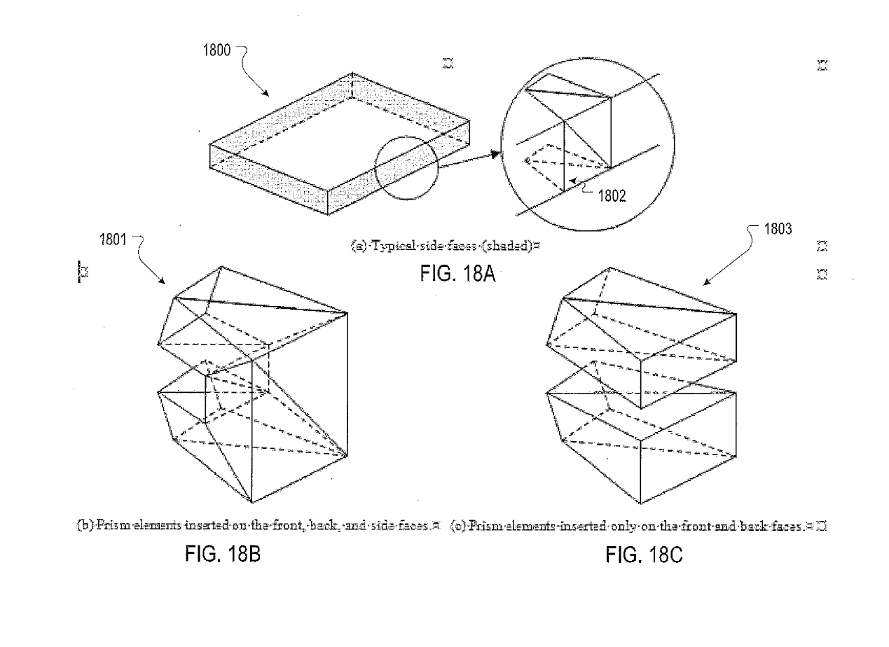

In an example, mesh generation engine 604 is configured to identify side faces. Generally, side faces connect the front and back of a solid (e.g., a thin walled solid). When side faces are identified, better quality elements can be generated, by mesh generation engine 604, by not placing a layer of prism elements on the identified region. Referring to FIG. 18A, thin-walled solid model 1800 includes dihedral angle 1802 between the front face (or the back face) and the side face that is nearly ninety degree.

If a layer of prism elements is inserted on the top, bottom, and side faces, two prism elements will share the dihedral angle between the front and side faces or back and side faces. Referring to FIG. 18B, mesh generation engine 604 generates configuration 1801 by layering prism elements on sides of thin-walled solid model 1800. In this example, two prism elements share the ninety degree angle, and a dihedral angle for each element on the side face is forty-five degrees.

Referring to FIG. 18C, mesh generation engine 604 generates configuration 1803 by inserting a layer of prism elements on the front and back faces of thin-walled solid model 1800. In this example, the inserted elements can be of higher quality (e.g., relative to a quality of the elements inserted in FIG. 18B), with a dihedral angle of ninety degrees. In an example, prism elements placed in the manner described with regard to FIGS. 18B,18C have increased scaled-Jacobian values, e.g., relative to Jacobian values that would result if the side faces were not identified.

### Prism-Layer Insertion

In an example, mesh generation engine 604 is configured to perform prism-layer insertion. Generally, prism-layer insertion includes a technique for inserting a layer of prisms in a mesh. In this example, a solid model includes a combination of thin-walled sub-volumes and bar-like sub-volumes. Bar-like volumes may be locally sweepable, including, e.g., that the volume can be meshed by sweeping methods known in the art.

In this example, an input geometric domain includes a sweepable bar-like sub-volume. Mesh generation engine 604 uses the techniques described herein, in conjunction with prism-layer insertion, to generate structured prism elements in the sweepable sub-volume.

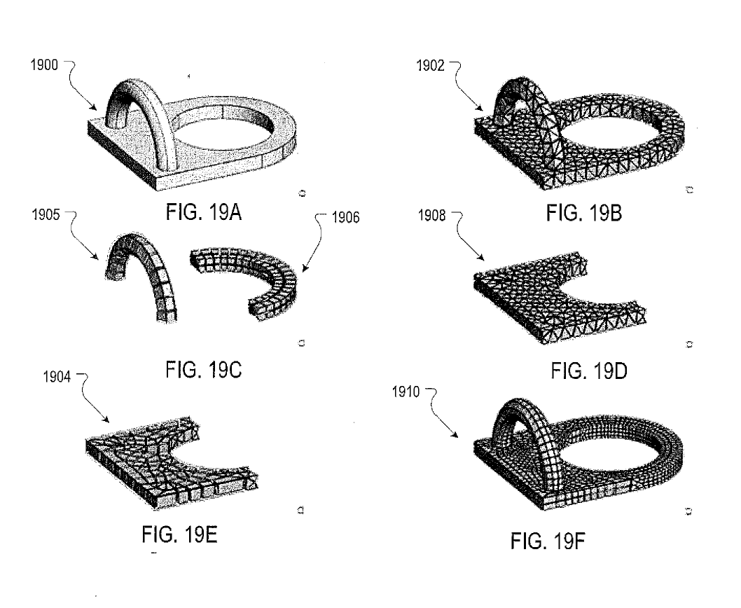

Referring to FIG. 19A, input geometric domain 1900 includes a union of a bar-like sub-volume and a thin-walled sub-volume. Referring to FIG. 19B, mesh generation engine 604 uses input geometric domain 1900 in generating tetrahedral mesh 1902. In this example, mesh generation engine 604 converts tetrahedral mesh 1902 to tetrahedral-prism-hexahedral mixed mesh 1904 (FIG. 19E) by prism-layer insertion.

Referring to FIG. 19C, mesh generation engine 604 generates prism elements 1905, 1906 by prism-layer insertion. Referring to FIG. 19D, mesh generation engine 604 generates tetrahedral elements 1908. Referring to FIG. 19E, mesh generation engine 604 inserts a layer of prism elements on the boundary of tetrahedral elements 1908, and a sequence of topological transformations and smoothing operations are applied to generate tetrahedral-prism-hexahedral mixed mesh 1904. Mesh generation engine 604 merges tetrahedral-prism-hexahedral mixed mesh 1904 with prism elements 1905, 1906. Referring to FIG. 19F, mesh generation engine 604 generates hexahedral mesh 1910 by subdividing elements of tetrahedral-prism-hexahedral mixed mesh 1904 merged with prism elements 1905, 1906.

### Local Application of the Mesh Generation Engine

In an example, an input geometric domain includes a relatively large or a relatively small solid angle feature, e.g., relative to sizes of other solid angle features. In this example, the relatively small solid angle feature may increase a difficulty in generating a hexahedral mesh, e.g., because corner angles of elements inserted on a boundary of the mesh are restricted by a corner angle of the input geometric domain.

In an example, mesh generation engine 604 is configured to promote generation of hexahedral meshes when the input geometric domain includes the foregoing solid angle feature. In this example, mesh generation engine 604 separates an tetrahedral mesh (e.g., generated from the input geometric domain) into two sets of elements, e.g., a first set of elements near the solid angle feature, and a second set of the other elements, before a layer of prism elements is inserted on the boundary.

Mesh generation engine 604 is configured to generate a mixed mesh by inserting a layer of prism elements on the boundary of the second set and applying a sequence of the topological transformations and smoothing operations. Mesh generation engine 604 is also configured to merge tetrahedral elements in the first set with the mixed mesh. Mesh generation engine 604 subdivides the elements in the mixed mesh into hexahedral elements and applies further smoothing operations.

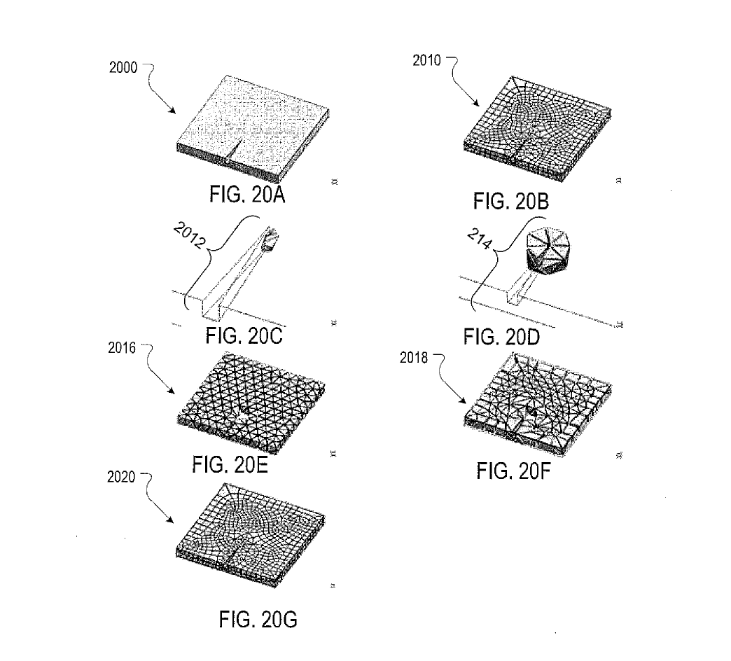

Referring to FIGS. 20A and 20B, thin-plate 2000 with a notch can be meshed into hexahedral mesh 2010, e.g., using the techniques described herein. In this example, hexahedral mesh 2010 includes elements 2012 with less-than-0.05 scaled Jacobian near the notch, e.g., as shown in FIG. 20C.

To generate a hexahedral mesh with improved Jacobian values (e.g., relative to the Jacobian values of hexahedral mesh 2010), mesh generation engine 604 is configured to separate a tetrahedral mesh (not shown) of thin-plate 200 into elements 2014 (FIG. 20D) near the deepest corner of the notch and other elements 2016 (FIG. 20E). Mesh generation engine 604 inserts a layer of prism elements on the boundary of elements 2014. Mesh generation engine 604 also applies a sequence of topological transformations and smoothing operations to elements 2016 to generate tetrahedral-prism-hexahedral mixed mesh 2018 (FIG. 20F). The elements 2014 are merged with mixed mesh 2018. Mesh generation engine 604 generates hexahedral mesh 2020 (FIG. 20G) by subdividing, into hexahedral elements, the elements included in mixed mesh 2018 merged with elements 2014.

In this example, hexahedral mesh 2020 has increased quality, e.g., relative to the quality of mesh 2010. In this example, only one element of hexahedral mesh 2020 has a scaled Jacobian value of 0.13. All other elements of hexahedral mesh 2020 have scaled Jacobian values of greater than 0.2.

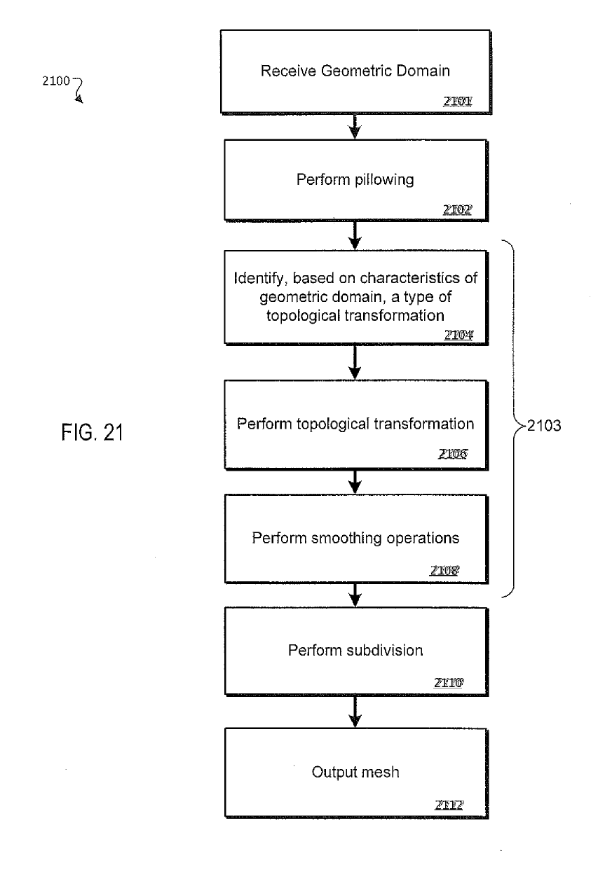

Referring to FIG. 21, mesh generation engine 604 performs process 2100 in generating meshes, including, e.g., meshes 100, 500. In operation, mesh generation engine 604 receives (2101), from client device 610, information indicative of a geometric domain, including, e.g., geometric domain 102. In this example, process 2100 includes various actions, including, e.g., the ones described below.

In the example of FIG. 21, mesh generation engine 604 performs pillowing (2102), e.g., to generate meshes 104, 105, 200. In this example, pillowing includes prism and tetrahedral mesh generation with a conventional tet-meshing method and prism pillowing. Mesh generation engine 604 also performs conformal transformation (2103), e.g., to generate meshes 114, 116, 118, 120, 300, 400. In this example, conformal transformation 2103 includes the actions of 2104, 2106, 2108. In operation, mesh generation engine 604 identifies characteristics of the generated mesh, including, e.g., types of geometric elements included in the generated mesh, placement of the geometric elements with regard to each other in the generated mesh, and so forth.

Based on the identified characteristics, mesh generation engine 604 identifies (2104) a type of topological transformation to be applied to the mesh generated from pillowing. As previously described, there are various types of topological transformations, including, e.g., edge collapse, prism swap, prism collapse, prism split, clamp, diamond collapse, half and full-wedge collapse, prism pairing, and so forth.

Mesh generation engine 604 performs (2106) the identified type of topological transformation. Mesh generation engine 604 also performs (2108) smoothing operations, e.g., in generating mesh 400. Mesh generation engine 604 performs (2110) subdivision on the mesh generated from actions 2106, 2108. In an example, mesh generation engine 604 generates mesh 100 by performing subdivision on mesh 120. In another example, mesh generation engine 604 generates mesh 500 by performing subdivision on one or more of meshes 300, 400. As previously described, mesh 500 includes a hexahedral mesh of hexahedral elements.

Mesh generation engine 604 also outputs (2122), to client device 610, a visual representation of mesh 500. For example, mesh generation 604 generates data for a graphical user interface that when rendered on client device 610 renders a visual representation of mesh 500.

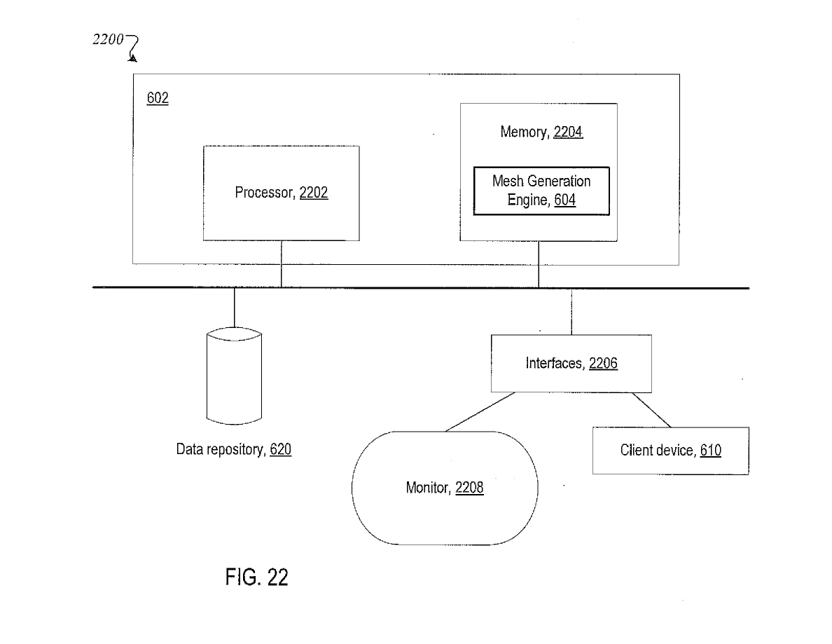

Referring to FIG. 22, components 2200 of an environment (e.g., environment 600) for generating meshes are shown. Client device 610 can be any sort of computing device capable of taking input from a user and communicating over a network (not shown) with server 602 and/or with other client devices. For example, client device 610 can be a mobile device, a desktop computer, a laptop, a cell phone, a personal digital assistant (“PDA”), a server, an embedded computing system, a mobile device and so forth. Client device 610 can include monitor 2208, which renders visual representations of interface 2206.

Server 602 can be any of a variety of computing devices capable of receiving information, such as a server, a distributed computing system, a desktop computer, a laptop, a cell phone, a rack-mounted server, and so forth. Server 602 may be a single server or a group of servers that are at a same location or at different locations.

Server 602 can receive information from client device 610 via interfaces 2206, including, e.g., graphical user interfaces. Interfaces 2206 can be any type of interface capable of receiving information over a network, such as an Ethernet interface, a wireless networking interface, a fiber-optic networking interface, a modem, and so forth. Server 602 also includes a processor 2202 and memory 2204. A bus system (not shown), including, for example, a data bus and a motherboard, can be used to establish and to control data communication between the components of server 602. In the example of FIG. 22, memory 2204 includes mesh generation engine 604.

Processor 2202 may include one or more microprocessors. Generally, processor 2202 may include any appropriate processor and/or logic that is capable of receiving and storing data, and of communicating over a network (not shown). Memory 2244 can include a hard drive and a random access memory storage device, such as a dynamic random access memory, machine-readable media, or other types of non-transitory machine-readable storage devices. Components 2200 also include data repository 620, which is configured to store information collected through server 602 and generated by server 602.

Embodiments can be implemented in digital electronic circuitry, or in computer hardware, firmware, software, or in combinations thereof. An apparatus for executing the techniques described herein can be implemented in a computer program product tangibly embodied or stored in a machine-readable storage device and/or machine readable media for execution by a programmable processor; and method actions can be performed by a programmable processor executing a program of instructions to perform functions and operations by operating on input data and generating output.

The techniques described herein can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Computer readable storage media are storage devices suitable for tangibly embodying computer program instructions and data include all forms of volatile memory such as RAM and non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

Other embodiments are within the scope and spirit of the description claims. In another example, due to the nature of software, functions described above can be implemented using software, hardware, firmware, hardwiring, or combinations of any of these. Features implementing functions may also be physically located at various positions, including being distributed such that portions of functions are implemented at different physical locations.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A method performed by one or more processors, comprising:
receiving information indicative of a geometric domain;
generating, based on the information indicative of the geometric domain, a mesh of geometric elements;
transforming a plurality of the geometric elements from a first type of geometric element to a second type of geometric element; and
subdividing the plurality of the geometric elements transformed from the second type of geometric element into a third type of geometric element.

2. The method of claim 1, wherein the first type of geometric element comprises one or more a tetrahedral element, a prism element and a hexahedral element;
wherein the third type of geometric element comprises a hexahedral element.

3. The method of claim 1, wherein transforming comprises:
applying a topological transformation.

4. The method of claim 3, further comprising:
determining, based on one or more characteristics of the mesh, a type of the topological transformation to be applied.

5. The method of claim 4, wherein the type of topological transformation comprises one or more of:
an edge collapse topological transformation;
a prism swap topological transformation;
a prism collapse topological transformation;
a prism split topological transformation;
a clamp topological transformation;
a diamond collapse topological transformation; a half and full-wedge collapse topological transformation; and
a prism pairing topological transformation.

6. The method of claim 1, wherein transforming comprises:
applying a smoothing operation to the geometric elements in the mesh;
wherein application of the smoothing operation removes from the mesh one or more of the geometric elements of the first type.

7. The method of claim 1, wherein subdividing comprises:
subdividing based on a mid-point subdivision template.

8. The method of claim 1, wherein the mesh comprises a substantially uniform node distribution following subdividing.

9. One or more machine-readable media configured to store instructions that are executable by one or more processors to perform operations comprising:
receiving information indicative of a geometric domain;
generating, based on the information indicative of the geometric domain, a mesh of geometric elements;
transforming a plurality of the geometric elements from a first type of geometric element to a second type of geometric element; and
subdividing the plurality of the geometric elements transformed from the second type of geometric element into a third type of geometric element.

10. The one or more machine-readable media of claim 9, wherein the first type of geometric element comprises one or more a tetrahedral element, a prism element and a hexahedral element; and
wherein the third type of geometric element comprises a hexahedral element.

11. The one or more machine-readable media of claim 9, wherein transforming comprises:
applying a topological transformation.

12. The one or more machine-readable media of claim 11, wherein the operations further comprise:
determining, based on one or more characteristics of the mesh, a type of the topological transformation to be applied.

13. The one or more machine-readable media of claim 12, wherein the type of topological transformation comprises one or more of:
an edge collapse topological transformation;
a prism swap topological transformation;
a prism collapse topological transformation;
a prism split topological transformation;
a clamp topological transformation;
a diamond collapse topological transformation; a half and full-wedge collapse topological transformation; and
a prism pairing topological transformation.

14. The one or more machine-readable media of claim 9, wherein transforming comprises:
applying a smoothing operation to the geometric elements in the mesh;
wherein application of the smoothing operation removes from the mesh one or more of the geometric elements of the first type.

15. The one or more machine-readable media of claim 9, wherein subdividing comprises:
subdividing based on a mid-point subdivision template.

16. The one or more machine-readable media of claim 9, wherein the mesh comprises a substantially uniform node distribution following subdividing.

17. An electronic system comprising:
one or more processors; and
one or more machine-readable media configured to store instructions that are executable by the one or more processors to perform operations comprising:
receiving information indicative of a geometric domain;
generating, based on the information indicative of the geometric domain, a mesh of geometric elements;
transforming a plurality of the geometric elements from a first type of geometric element to a second type of geometric element; and
subdividing the plurality of the geometric elements transformed from the second type of geometric element into a third type of geometric element.

18. The electronic system of claim 17, wherein the first type of geometric element comprises one or more a tetrahedral element, a prism element and a hexahedral element; and
wherein the third type of geometric element comprises a hexahedral element.

19. The electronic system of claim 17, wherein transforming comprises:
applying a topological transformation.

20. The electronic system of claim 19, wherein the operations further comprise:
determining, based on one or more characteristics of the mesh, a type of the topological transformation to be applied.

21. The electronic system of claim 20, wherein the type of topological transformation comprises one or more of:
an edge collapse topological transformation;
a prism swap topological transformation;
a prism collapse topological transformation;
a prism split topological transformation;
a clamp topological transformation;
a diamond collapse topological transformation; a half and full-wedge collapse topological transformation; and
a prism pairing topological transformation.

22. The electronic system of claim 17, wherein transforming comprises:
applying a smoothing operation to the geometric elements in the mesh;
wherein application of the smoothing operation removes from the mesh one or more of the geometric elements of the first type.

23. The electronic system of claim 17, wherein subdividing comprises:
subdividing based on a mid-point subdivision template.

24. The electronic system of claim 17, wherein the mesh comprises a substantially uniform node distribution following subdividing.
